(19) United States
(12) Patent Application Publication
(10) Pub. No.: US 2020/0219341 A1
(43) Pub. Date: Jul. 9, 2020

(54) INTELLIGENT SECURE KEYPAD KEYLESS TRANSMITTER

(71) Applicant: Abdulla Khalid, Laguna Niguel, CA (US)

(72) Inventor: Abdulla Khalid, Laguna Niguel, CA (US)

(21) Appl. No.: 16/733,561

(22) Filed: Jan. 3, 2020

Related U.S. Application Data
(60) Provisional application No. 62/788,735, filed on Jan. 4, 2019.

(51) Int. Cl. G07C 9/00

(52) U.S. Cl. CPC G07C 9/00309; G07C 2009/00769; G07C 2009/00928

(57) ABSTRACT

Intelligent secure keyless keypad transmitter entry system mounted outside property integrated into an existing motorized garage door opening system or any motorized gate system for secure entry and package delivery using a barcode scanner. Device uses package tracking codes stored in advance to open door or gate with a delivery notification to owner. Motion detection and facial recognition biometric camera allows invited persons to enter property. The camera and microphone/speaker allow video communication via mobile device. The keypad with LED screen can be programmed with temporary or permanent PIN codes for entry code allowing owner to verify access and exit of service providers. Entry Device offers complete remote control of device functions and all activity on the device to be transmitted electronically to owner's mobile device. The unique cover of the wireless keypad contains a photovoltaics cells power for continuous device charging.

### CROSS-REFERENCES TO RELATED APPLICATIONS

This application is a non-provisional and claims benefit of U.S. Patent Application No. 62/788,735, filed Jan. 4, 2019, the specification(s) of which is/are incorporated herein in their entirety by reference.

### BACKGROUND OF THE INVENTION

The present invention relates to a secure garage door or other barrier entry with keyless opening method to be used for a home delivery, alternative entry to the premises through the garage door of which opened and closed through a keypad or Barcode sensors, facial recognition camera system and or terminal such as a mobile APP.

### DESCRIPTION

The present invention relates to the general field of garage door or other barrier entry operators, and more particularly, to an external wall mountable intelligent secure keypad keyless menu driven, or wireless programmable console device and wirelessly connected through home network and or Mobile App for such operators.

In the art of garage door operators and the like, it is conventional practice to provide a wall mountable, keypad menu driven, console device to control a door operator from the exterior of a building or a residential dwelling. Console devices known in the art are of various sophistication and user friendliness. Some console devices may be hardwired to the door operator. Other console devices may provide a wireless user interface to the door operator. Still other console devices may allow for a key-like entry system to gain access. Yet other console devices provide access to operation of the garage door after performing a keypad type entry.

It is conventional practice for some console devices to grant access only after entering a user identification or authorization code such as a Personal Identification Number (PIN), of their own choosing, Console devices.

Some conventional console devices provide programming feedback by a blinking light emitting diode (LED). Blinking LEDs fail to convey the nature of an error or confirm an entry while programming. Thus, blinking LEDs in conventional console devices make programming a user determined PIN tedious and difficult.

Because console devices with blinking LEDs offer limited feedback and thus have limited programming capabilities, they also have limited functional capabilities. For example, such console devices lack certain functional capabilities such as the ability to easily program and control more than one door, program more than one unique PIN or to create a separate temporary PIN. Limiting the functional capabilities of a console device limits the usefulness and efficiency of a given console device.

### SUMMARY OF THE INVENTION

The present invention provides an improved wall mountable, console device for intelligent secure keypad keyless entry type wall console devices of garage doors, gates and like barriers. The invention provides a wall mountable console device that replaces cumbersome conventional numeric keypad programming with an easy to follow menu driven programming methodology and or a connected mobile App. The invention further provides a menu driven programming methodology where individual visual indicators signal a menu choice. The present invention conveys the nature of secure entry and provides a user with meaningful programming and instant feedback with on the LED screen console or connected mobile App.

The present invention provides a number of advantages over prior art console devices including the ability to easily program the console device by using an LED screen driven menu and or wirelessly connected Mobile device with intelligent App. The LED screen driven menu provides instant feedback during the programming session or during normal use. And provide wireless feedback to a connected Mobile device. The LED driven menu and the wirelessly connected Mobile device may include a “READY” LED to provide information on whether the device is in “home” or ready state and an “ERROR” LED to provide a user with feedback on conditions. The LED screen driven menu may further include items related to PINs and door designator references.” LED. The present invention also provides an easily ascertainable indication on the health and the condition of the intelligent keypad with the LED screen or wirelessly connected device and/or through the home network.

The present invention provides other advantageous features and increased programming capabilities, while maintaining an easily accessible through the keypad console or wirelessly connected Mobile device and or home network with a simply designed interface. The interface includes, for example, Barcode Scanner, Motion detection inferred camera with biometric facial recognition features to aid in the programming and in the operation of the console device by providing user-accessible switches for selecting, entering or canceling any menu option or entry. A user can easily program the same PIN for multiple doors using the same console device, program multiple PINs for a single door and create a separate temporary PIN for a single door or more than one door.

A User can upload wirelessly any tracking numbers from any Internet purchased directly to the intelligent secure keypad keyless to allow secure delivery using the barcode scanner on the intelligent secure keypad keyless with photo and video confirmation of the delivery and instant confirmation relied wirelessly to the connected Mobile device. Gone the day with package theft from the front of the premises.

A user can program the biometric facial recognition to allow family and friend easy access to the premises with instant confirmation of the entry relied to the connected Mobile device. Also, the infrared camera can act as a security camera with motion detection and live video feed of the front of the property.

### BRIEF DESCRIPTION OF THE SEVERAL VIEWS OF THE DRAWING

The accompanying drawings, being incorporated in and forming a part of this specification, illustrate embodiments of the invention and, together with the description, serve to explain the principles of the present invention:

FIG. 1 is a perspective view of a preferred embodiment of keyless intelligent secure keypad wall console device of the present invention;

FIG. 2 is a perspective front view of a panel of a wireless intelligent secure keypad garage door opener according to an embodiment of the present invention;

FIG. 3 is a perspective Back view of panel of a wireless intelligent secure keypad garage door opener according to an embodiment of the present invention;

FIG. 4; is a perspective Top view of panel of a wireless intelligent secure keypad garage door opener according to an embodiment of the present invention:

FIG. 5 is a perspective Bottom view of panel of a wireless intelligent secure keypad garage door opener according to an embodiment of the present invention;

FIG. 6 is a perspective Left side view of panel of a wireless intelligent secure keypad garage door opener according to an embodiment of the present invention;

FIG. 7 is a perspective Right-side view of panel of a wireless intelligent secure keypad garage door opener according to an embodiment of the present invention;

FIG. 8 is a perspective ISO view of panel of a wireless intelligent secure keypad garage door opener according to an embodiment of the present invention;

FIG. 9 is a perspective front cover view of panel of a wireless intelligent secure keypad garage door opener according to an embodiment of the present invention;

FIG. 10 is a perspective ISO with Photovoltaic modules cover view of panel of a wireless intelligent secure keypad garage door opener according to an embodiment of the present invention;

### DETAILED DESCRIPTION OF INVENTION

The various embodiments and variations thereof illustrated in the accompanying Figures and/or described herein are merely exemplary and are not meant to limit the scope of the invention. It is to be appreciated that numerous variations of the invention have been contemplated as would be obvious to one of ordinary skill in the art with the benefit of this disclosure. Rather, the scope and breadth afforded this document should only be limited by the claims provided herein while applying either the plain meaning to each of the terms and phrases in the claims or the meaning clearly and unambiguously provided in this specification.

In the description that follows, like elements are marked throughout the specification and drawings with the same reference numerals, respectively. The drawing figures are not necessarily to scale and certain elements may be shown in somewhat generalized or schematic form in the interest of clarity and conciseness. Commercially available circuit elements are used throughout.

The present invention comprises an improved wireless connected App driven intelligent secure keypad keyless wall console device.

### Terminology

The terms and phrases as indicated in parenthesis (“ ”) in this section are intended to have the meaning ascribed to them in this section applied to them throughout this document including the claims unless clearly indicated otherwise in context.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “embodiments”, “variations”, “a variation” and similar phrases mean that a particular feature, structure, or characteristic described in connection with the embodiment(s) or variation(s) is included in at least an embodiment or variation of the invention. The appearances of the phrase “in one embodiment” or “in one variation” in various places in the specification are not necessarily all referring to the same embodiment or variation.

The term “couple” “coupled”, “connected”, “joined”, “welded”, “glued”, “attached” or “fixed” as used in this specification and the appended claims refers to either an Indirect or direct connection between the identified elements, components or objects. Often the manner of the coupling will be related specifically to the manner in which the two coupled elements interact.

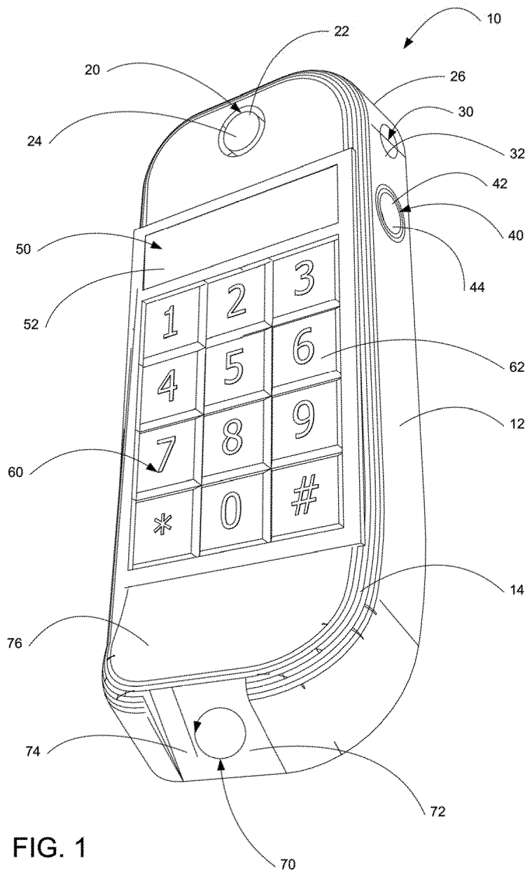

FIG. 1 illustrates the remote-control system in accordance with the preferred embodiment of the present invention including a plurality of keyless wall console device 10. The console device 10 is particularly adapted to mount on an exterior wall of a residential garage, not shown, for use in opening or closing a garage door also not shown. To provide secure safe package deliveries and control access to the premises the console device 10 essentially comprises seven major structural components, suitable weather proof housing 12, 20, 30, 40, 50, 60, 70 and a cover 80.

FIG. 1 depicts the console device 10 with the, Barcode Scanner 70, 72, 74, a motion detection Facial recognition infrared camera 20, 22, 24 a side camera optional for left or right side installation 30, microphone speaker 40, 42, 44 LED screen 50, 52 and numerical backlight keypad 60, 62 console device 10 will have three separate configuration front, left, or right side installation device 10 allows a user to upload tracking number from online purchasing through a companion app not showing so that a deliver antitea can access the garage for secure safe delivery through the barcode scanner 70, 72, 74 The motion detection facial recognition camera 180 degrees field of view 20, 22, 24 will allow user to program facial images family member and friend to easy access to the property with full control and notification access the camera 20, 22, 24 and 30, 32 can be setup as parameter security system the microphone speaker 4042, 44 will have a 2 way conversion and can be used with the cameras 20 and or 30 for video conference and communication camera 20 or 30 can be setup for motion detection and early warning of unauthorized person coming close to the premises. to operate the garage door with multiple ways using the barcode 70, 72, 74 access code keypad 60, 62 facial recognition 20, 22, 24 and or 30, 32 remote control though companion App can be programmable through WIFI and or Bluetooth the console device will incorporate a WIFI and Bluetooth low energy capability connected to the home network a to allow update, programming, adding and removing users, adding features, integrating with Mobile devises desktop laptop that connected to the home network or through voice activation with Bluetooth and near field communication. The system will be compliance with IGT All the programming functions are software application will be programmed into the device and are not shown in this depiction of the intelligent secure keypad keyless. all the functionality open command close command will be connected and integrates into an existing motorized garage door opening or any motorized gate system wirelessly or hardwired this will replace the garage door clickers.

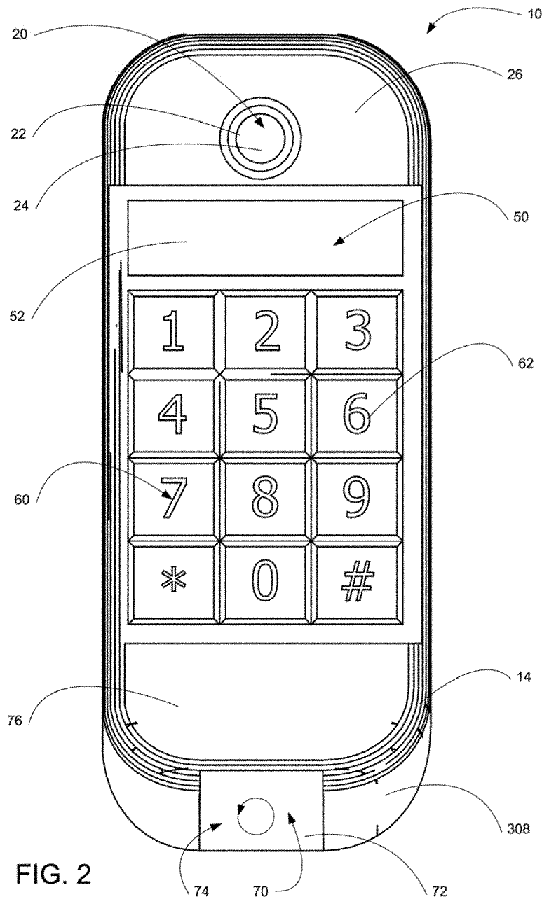

FIG. 2, a perspective view of a front panel of a intelligent secure keypad keyless garage door opener keypad unit according to an embodiment of the present Invention as shown in FIG. 2, an enter backlight keypad 60, 62 comprises a functional key which enables the selection of various features of the wireless garage door opener keypad unit. The enter key may be used to delineate certain functions and enter data for implementing various functions of the wireless garage door opener keypad unit. While other embodiments may have a dedicated program key, the enter key may function not only to enter an identification code, but also to store a secondary identification code, and to enable and disable or erase a secondary identification code, wireless garage door opener keypad unit enable the movement of a cover, as will show and art.

FIG. 2 showing the front camera and housing, 22, 24 the barcode scanner and housing 70, 72, 74 backlight keypad placement 60, 62 and the LED screen 50, 52 for a visual indicator array or menu of the input of data. the front camera 20 FIG. 2/10 and the side camera 30 FIG. 1/10 are connected to the home network with WIFI and Bluetooth low energy chip connect through IOT the internet of things this is a software function is not shown in this art. All the functionality open command close command will connect to the garage door system wirelessly or hardwired,

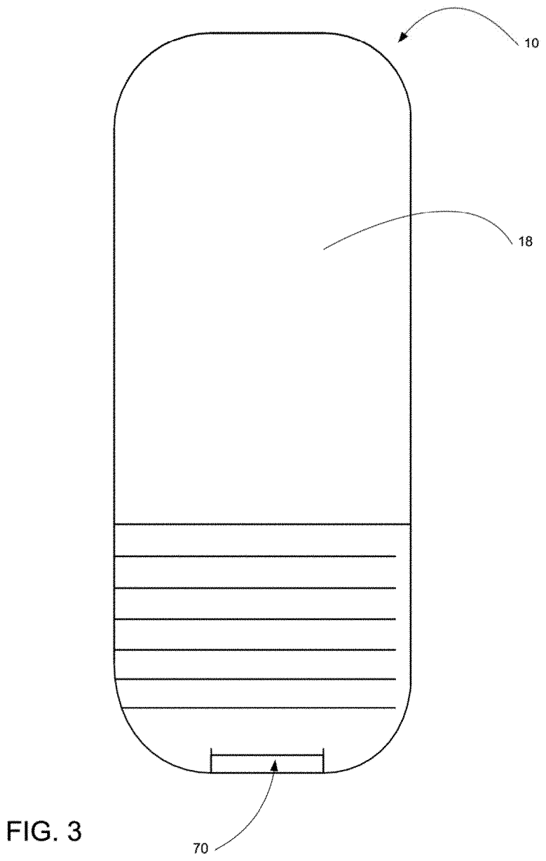

FIG. 3 is a perspective view of a Back panel of the intelligent secure keypad keyless wireless garage door opener keypad according to an embodiment of the present invention as shown a Battery housing 18 this is the housing for the battery that will be needed to operate the garage door the battery is not included in this drawing, opener and the back of the scanner unite 70 not included in this drawing.

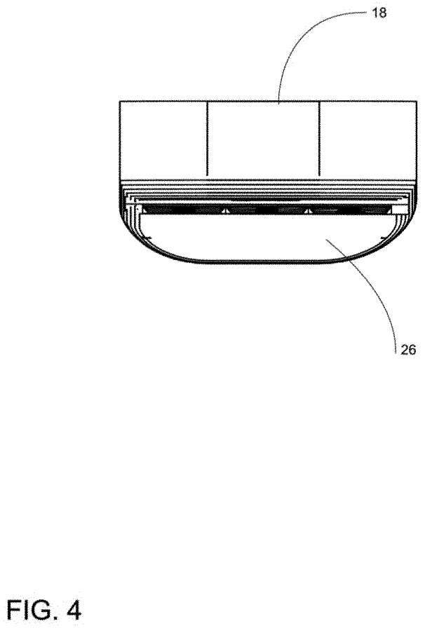

FIG. 4 is a perspective Top view of panel of a wireless intelligent secure keypad garage door opener according to an embodiment of the present invention 26

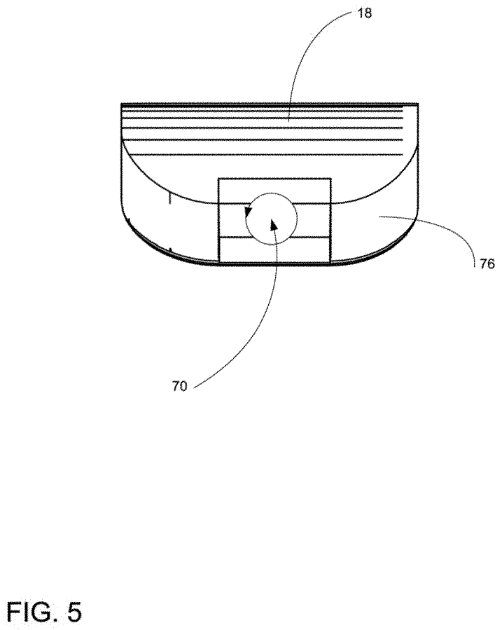

FIG. 5 is a perspective Bottom view of panel of a wireless intelligent secure keypad garage door opener according to an embodiment of the present invention with the scanner housing 70 and the back console 18. The barcode scanner is connected to the home network and work in tandem with wireless garage door mechanism, the scanner is uploaded with relevant barcode or tracking numbers all tracking numbers and barcode are stored to be utilized by the deliver personal to access the garage door opener once the item is scanned the system will confirm the barcode or tracking number are loaded and will initiate the sequence of opening the garage door once the function is completed the info will be removed from the system and a confirmation notification will be transmitted to the user all the functionality open command close command will connected and integrates into an existing motorized garage door opening or any motorized gate system wirelessly Or hardwired this will replace the garage door clickers.

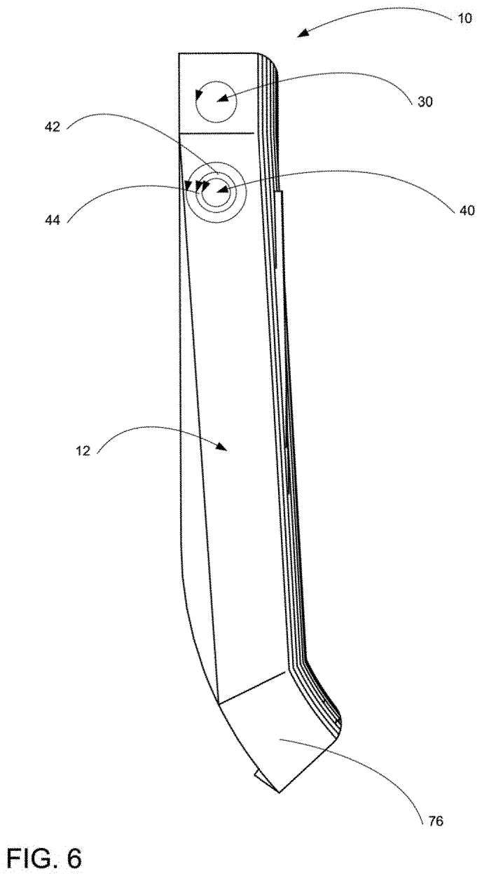

FIG. 6 is a perspective Left side view of panel of a wireless intelligent secure keypad garage door opener according to an embodiment of the present invention. As shown side camera 30 Microphone with Speaker 40 42, 44, scanner housing 76 The microphone Speaker 40, 42, 44 will be able to connect and communicate with home network to a Mobile device through the home WIFI and will be able to listen ready to communicate, and relay voice this feature is software application not depicted in this art.

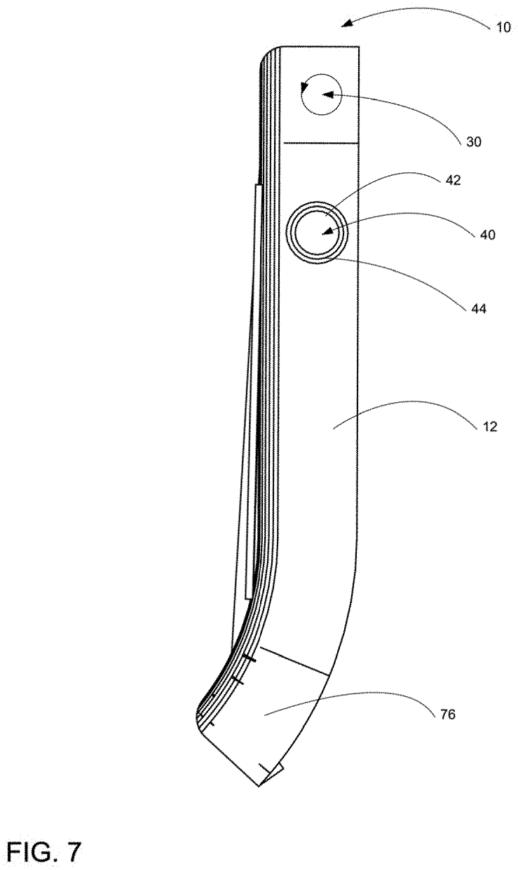

FIG. 7 is a perspective Right-side view of panel of a wireless intelligent secure keypad garage door opener according to an embodiment of the present invention as shown side camera 30, Microphone Speaker 40, 42, 44 side of weather proof housing 12, and scanner housing 76

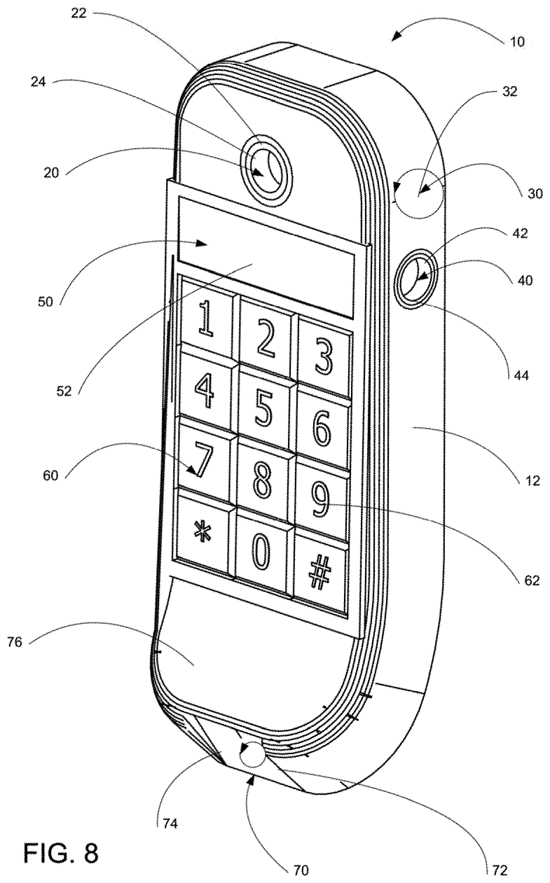

FIG. 8 is a perspective ISO view of panel of a wireless intelligent secure keypad garage door opener according to an embodiment of the present invention the optional side camera 30, 32 Microphone speaker 40, 42, 44 and the scanner housing 76, 72, 74, 76 front camera 20, 22, 24, LED screen 50, 52, backlight keypad 60, 62 and weather proof housing 12. Wireless intelligent secure keypad garage door opener will have the capability to integrate with Mobile devices and voice activated features the likes of the apple Sri Amazon Alexa or Google voice. This function is software app that is not shown in this art.

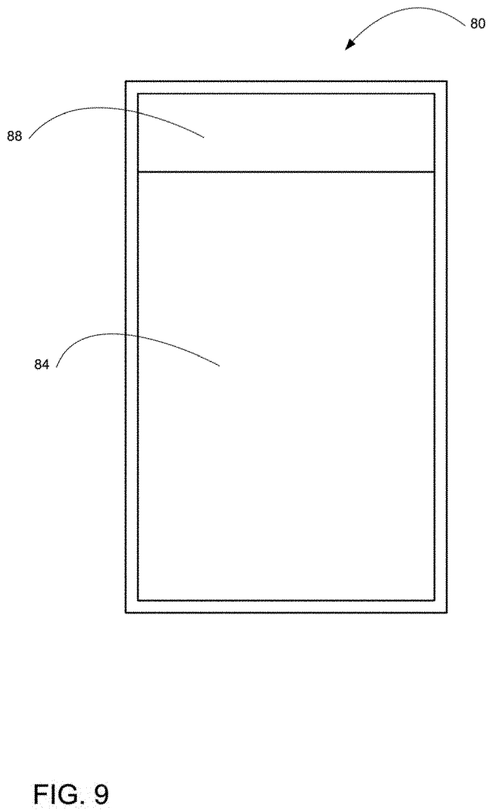

FIG. 9 is a perspective front cover view of panel of a wireless intelligent secure keypad garage door opener according to an embodiment of the present invention as shown FIG. 80 with LED screen opening 88 and the front of the weather proof housing cover with A solar cell, or photovoltaic cell to maintain battery fully charged to unable scanner 70, 72, 74, Front camera 20, 22, 24 side camera 30, 40, 42, 44 and the LED screen 50, 52 as well as the LED backlight keypad 60, 62 fully charged and operational.

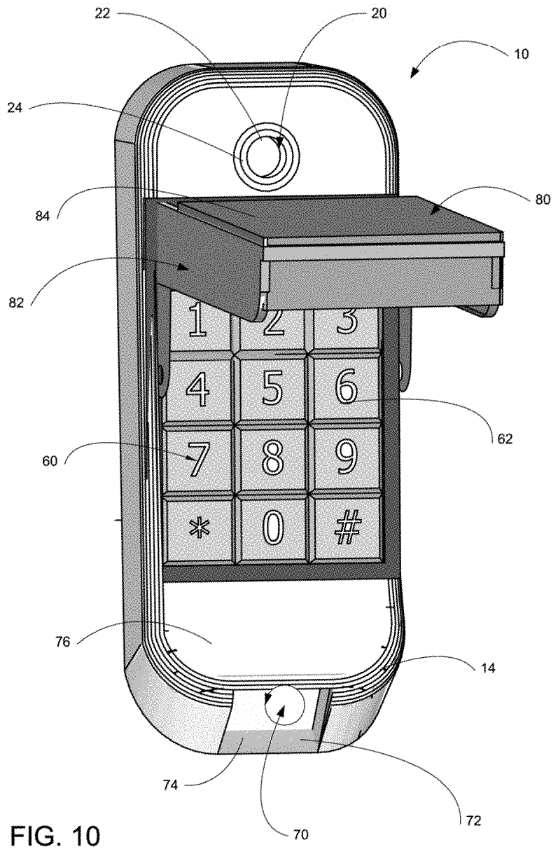

FIG. 10 is a perspective ISO with Photovoltaic modules cover view of panel of a wireless intelligent secure keypad garage door opener according to an embodiment of the present invention as shown FIG. 10 front camera 20, 22, 24, Front of the console cover with solar cell, or photovoltaic cell 80, 82, 84, backlight keypad 60, 62, scanner housing with scanner 70, 72, 74, 76 and the curvature of housing 12 depicted on disarm 14, cover 80 in the accessible or open position. The cover 80 is preferably hingably attached to the 12 of the housing for easy access and for protection from weather elements when in a closed position. When the cover 80 is in a closed position the solar cell, or photovoltaic cell modular will commence in producing DC current to maintain battery fully charged connection of the cover with solar cell, or photovoltaic cell is not depicted in this drawing.

The present invention may also be advantageously employed in a security system. Unit 10 may be used as front of the premises security system anti-theft system monitoring system and controlled access to the premises without invading the privacy of the inhabitant on the premises.

Although a preferred embodiment of a menu driven wall console device 10 and various embodiments of the present invention are discussed in detail herein, it will be appreciated that the present invention provides many applicable inventive concepts that can be embodied in a wide variety of specific contexts. For example, while the description has principally referenced an operator for a garage door, it is to be understood that the console of the present invention may also be utilized for gate and other barrier operators. The specific embodiments discussed herein are merely illustrative of specific ways to make and use the invention, and do not delimit the scope of the invention. Those skilled in the art will recognize that various substitutions and modifications may be made to the invention without departing from the scope and spirit of the appended claims.

What is claimed is:

1. A keyless security system capable of being automatically operated by the use of any cellular mobile phone or similar wireless communicator device supporting any standard short-range infrared, wireless Bluetooth, or WIFI between devices to enable entry or activation or deactivation of PIN code and similar access control applications.
